(19) United States
(12) Patent Application Publication
(10) Pub. No.: US 2026/0077709 A1
(43) Pub. Date: Mar. 19, 2026

(54) VEHICLE FOLLOWING TRAVELING SYSTEM

(71) Applicant: TOYOTA JIDOSHA KABUSHIKI KAISHA, Toyota-shi (JP)

(72) Inventors: Katsutoshi TSUZUKI, Nagoya-shi (JP); Daigo YAMAMOTO, Toyota-shi (JP)

(73) Assignee: TOYOTA JIDOSHA KABUSHIKI KAISHA, Toyota-shi (JP)

(21) Appl. No.: 19/202,171

(22) Filed: May 8, 2025

(30) Foreign Application Priority Data
Sep. 13, 2024 (JP) 2024-159466

(51) Int. Cl. B60Q 1/50; B60Q 1/54

(52) U.S. Cl. CPC B60Q 1/547; B60Q 1/54

(57) ABSTRACT

In the vehicle following traveling system, the preceding vehicle and the succeeding vehicle are non-mechanically linked to each other and the succeeding vehicle is caused to follow the preceding vehicle, and while the succeeding vehicle is caused to follow the preceding vehicle, light is emitted from the preceding vehicle or the succeeding vehicle toward the road surface between the preceding vehicle and the succeeding vehicle to draw a display having a predetermined shape on the road surface.

### CROSS-REFERENCE TO RELATED APPLICATION

This application claims priority to Japanese Patent Application No. 2024-159466 filed on September 13, 2024. The disclosure of the above-identified application, including the specification, drawings, and claims, is incorporated by reference herein in its entirety.

### BACKGROUND

### 1. Technical Field

The present disclosure relates to a vehicle following traveling system in which a preceding vehicle causes a succeeding vehicle to travel following the preceding vehicle.

### 2. Description of Related Art

A vehicle following traveling system is known in which a preceding vehicle and a succeeding vehicle are non-mechanically linked to each other and the succeeding vehicle is caused to travel following the preceding vehicle. For example, Japanese Unexamined Patent Application Publication No. 2019-001227 (JP 2019-001227 A) discloses a vehicle following traveling system that is capable of suppressing other vehicles from cutting in between a preceding vehicle and a succeeding vehicle.

### SUMMARY

However, in the vehicle following traveling system of JP 2019-001227 A, steering or braking of the succeeding vehicle needs to be finely controlled in order to suppress other vehicles from cutting in between the preceding vehicle and the succeeding vehicle. In this case, traveling control of the succeeding vehicle becomes complicated.

Accordingly, an object of the present disclosure is to provide a vehicle following traveling system that is capable of suppressing other vehicles from cutting in between a preceding vehicle and a succeeding vehicle, without performing complicated traveling control of the succeeding vehicle.

A vehicle following traveling system according to the present disclosure is a vehicle following traveling system for non-mechanically linking a preceding vehicle and a succeeding vehicle with the preceding vehicle causing the succeeding vehicle to travel following the preceding vehicle, in which, while the preceding vehicle is causing the succeeding vehicle to travel following the preceding vehicle, light is emitted from the preceding vehicle or the succeeding vehicle toward a road surface between the preceding vehicle and the succeeding vehicle, to draw a display with a predetermined shape on the road surface.

With the above configuration, other vehicles can be suppressed from cutting in between the preceding vehicle and the succeeding vehicle, without the succeeding vehicle performing complicated traveling control while the succeeding vehicle travels following the preceding vehicle.

In the vehicle following traveling system according to the present disclosure, preferably, when a headlight of the preceding vehicle or the succeeding vehicle is on, the display is drawn.

With the above configuration, the display is not drawn by a road surface drawing device during the daytime in which the headlight is not turned on. Accordingly, the amount of light at the time of drawing by the road surface drawing device can be suppressed to no more than a predetermined amount of light. As a result, power consumption of the road surface drawing device can be reduced.

In the vehicle following traveling system according to the present disclosure, preferably, when the preceding vehicle or the succeeding vehicle is stopped or is traveling at a speed no faster than a predetermined vehicle speed, the display is drawn.

With the above configuration, the display is not drawn by the road surface drawing device at a vehicle speed greater than the predetermined vehicle speed, at which a pedestrian will not enter between the preceding vehicle and the succeeding vehicle. Thus, the power consumption of the drawing device can be reduced. Also, when the succeeding vehicle is stopped before performing unmanned following traveling, for example, pedestrians in the vicinity of the succeeding vehicle can be made to recognize that the succeeding vehicle is going to travel by following traveling. As a result, pedestrians in the vicinity of the succeeding vehicle can be suppressed from passing in front of the succeeding vehicle that will perform following traveling.

In the vehicle following traveling system according to the present disclosure, preferably, when a pedestrian is detected within a predetermined range behind the preceding vehicle or within a predetermined range ahead of the succeeding vehicle, the display is drawn in red.

With the above-described configuration, when a pedestrian in the vicinity attempts to enter the predetermined range rearward of the preceding vehicle or the predetermined range forward of the succeeding vehicle, a warning can be given to the pedestrian.

In the vehicle following traveling system according to the present disclosure, it is preferable that a part of the display is not drawn when an inter-vehicle distance between the preceding vehicle and the succeeding vehicle is no greater than a predetermined distance.

With the above configuration, when the inter-vehicle distance between the preceding vehicle and the succeeding vehicle is no greater than the predetermined distance, a situation in which display of a road surface drawing overlaps with the preceding vehicle or the succeeding vehicle can be circumvented.

In the vehicle following traveling system according to the present disclosure, preferably, a drawing angle of the display is synchronized with a steering angle of the preceding vehicle or the succeeding vehicle.

With the above configuration, when the preceding vehicle or the succeeding vehicle travels around a curve, a display can be drawn between the preceding vehicle and the succeeding vehicle along the curve.

According to the vehicle following traveling system of the present disclosure, other vehicles can be suppressed from cutting in between the preceding vehicle and the succeeding vehicle, without having to perform complicated traveling control of the succeeding vehicle while the succeeding vehicle is traveling following the preceding vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a vehicle following traveling system that is an example of an embodiment;

FIG. 2 is a block diagram illustrating a configuration of a control device;

FIG. 3A is a schematic view showing another view of a road surface drawing;

FIG. 3B is a schematic view showing another view of a road surface drawing;

FIG. 3C is a schematic view showing another view of a road surface drawing;

FIG. 4 is a diagram for explaining an emission range of road surface drawing;

FIG. 5 is a diagram for describing steering angle interlocking control of road surface drawing; and

FIG. 6 is a flowchart for explaining the flow of the operation of the road surface drawing ECU.

### DETAILED DESCRIPTION OF EMBODIMENTS

Hereinafter, an example of the embodiment of the present disclosure will be described in detail. In the following description, specific shapes, materials, directions, numerical values, and the like are examples for facilitating the understanding of the present disclosure, and can be appropriately changed according to applications, purposes, specifications, and the like.

### Vehicle following traveling system

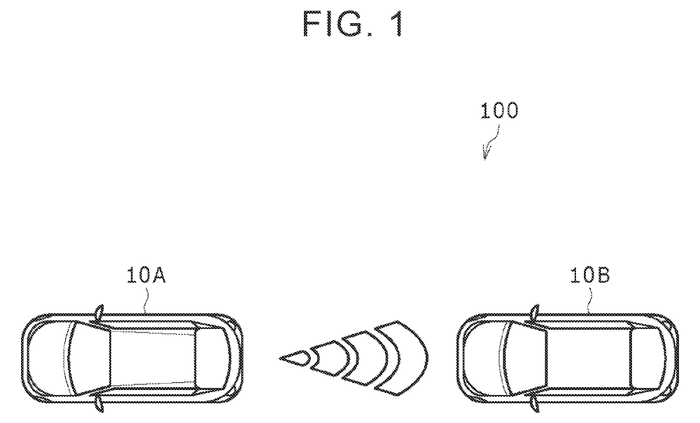

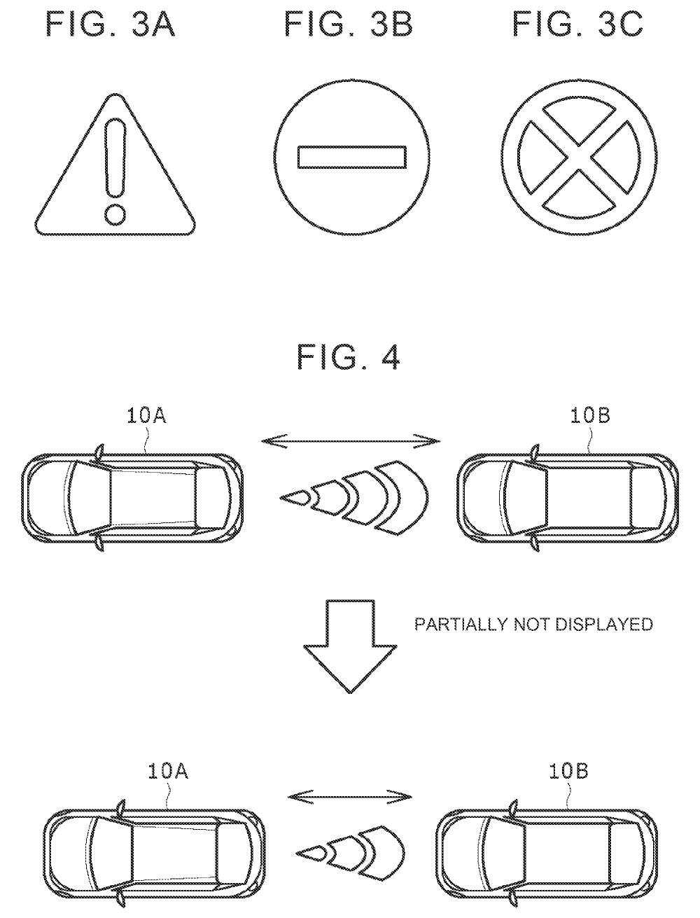

The vehicle following traveling system 100 will be described with reference to FIGS. 1 to 5.

As illustrated in FIG. 1, the vehicle following traveling system 100 is a system that non-mechanically links the preceding vehicle 10A and the succeeding vehicle 10B, and causes the succeeding vehicle 10B to follow in the preceding vehicle 10A. As will be described later, in the vehicle following traveling system 100, while the succeeding vehicle 10B is caused to follow the preceding vehicle 10A, light is emitted from the preceding vehicle 10A or the succeeding vehicle 10B toward the road surface between the preceding vehicle 10A and the succeeding vehicle 10B to draw a predetermined-shape display on the road surface. According to the vehicle following traveling system 100, interruption between the preceding vehicle 10B and the succeeding vehicle 10A can be suppressed without the succeeding vehicle 10B performing complicated traveling control.

The vehicle 10 (including the preceding vehicle 10A and the succeeding vehicle 10B) of the present embodiment is a four-wheel vehicle. Note that the vehicle of the present disclosure is not limited to a four-wheel vehicle. The vehicle of the present disclosure may be a two-wheeled vehicle or another vehicle.

Non-mechanically linking means that the succeeding vehicle 10B automatically travels while keeping the distance between the preceding vehicle 10A and the succeeding vehicle 10B constant. Note that the vehicle following traveling system 100 may further configure a plurality of vehicles 10 in which the vehicle 10 (succeeding vehicle 10B) follows the succeeding vehicle 10B and continuously travels. In this case, other than the first or last vehicle 10, the preceding vehicle 10A or the succeeding vehicle 10B is also obtained.

### When the road surface drawing device is on the front side of the vehicle

Hereinafter, a case where the road surface drawing device 45 is provided on the front side of the vehicle 10 will be described. In this case, the succeeding vehicle 10B performs road surface drawing toward the front. Hereinafter, the vehicle 10 in the succeeding vehicle 10B will be described.

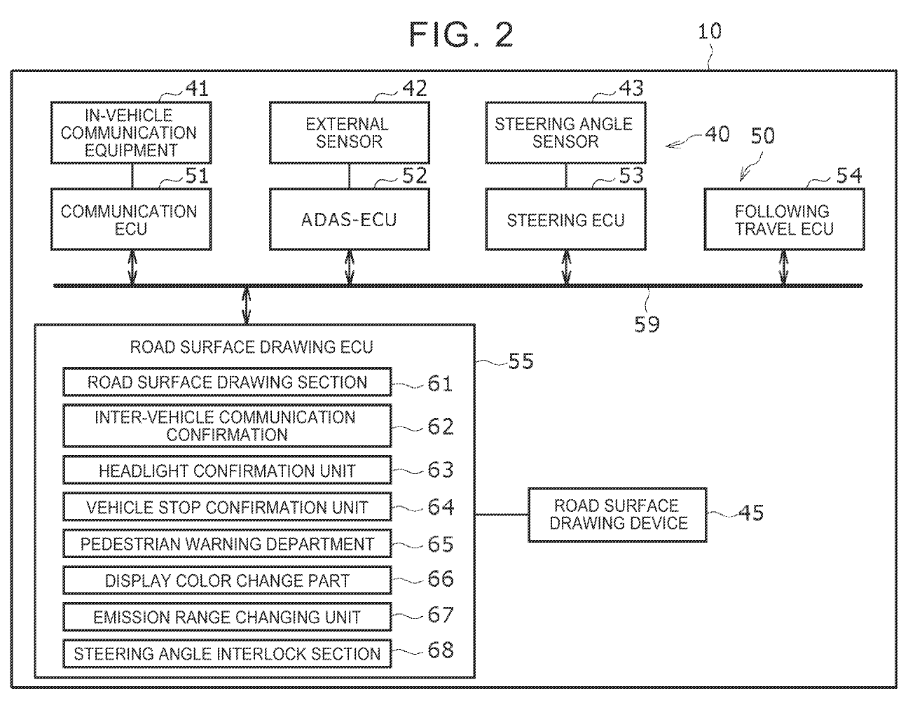

As illustrated in FIG. 2, each of the vehicles 10 includes an in-vehicle device 40 and an ECU 50 (Electronic Control Unit), which will be described later.

ECU 50 includes a communication ECU 51, an ADAS-ECU 52 (Advanced Driver Assistance System-ECU), a steering ECU 53, a following travel ECU 54, and a road surface drawing ECU 55. The communication ECU 51, ADAS-ECU 52, the steering ECU 53, the following travel ECU 54, and the road surface drawing ECU 55 are connected to each other by a buss 59 to exchange data with each other. Note that the vehicles 10 may include other ECU.

Each ECU includes a processor typified by a CPU, a storage device such as a semiconductor memory, and interfaces with external devices. The storage device stores a program executed by the processor, data used for processing by the processor, and the like. Each ECU may include a plurality of processors, storage devices, interfaces, and the like.

The communication ECU 51 communicates with the vehicle 10A via the vehicle communication device 41 as the in-vehicle 40. The in-vehicle communication device 41 is a communication device that performs inter-vehicle communication. The in-vehicle device 41 receives the communication data transmitted by the preceding vehicle 10A via the inter-vehicle communication. The communication information includes a traveling condition (vehicle speed, steering angle, and the like) of the preceding vehicle 10A.

ADAS-ECU 52 performs overall control of the advanced driving support system. An external sensor 42 constituting the in-vehicle device 40 is connected to ADAS-ECU 52. The external sensor 42 is a sensor group used for detecting the surrounding environment of the vehicle 10. The external sensor 42 includes, for example, a camera that captures an image of the surroundings of the vehicle 10, a millimeter wave radar that transmits a probe wave and receives a reflected wave, a lidar that scans the front of the vehicle 10, and the like. The external sensor 42 includes a road surface color detection sensor that detects a color of a road surface on which the vehicle 10 is traveling.

The steering ECU 53 controls the power steering. A steering angle sensor 43 and a steering actuator constituting the in-vehicle device 40 are connected to the steering ECU 53. The steering angle sensor 43 is a sensor that detects a steering angle of the steering wheel.

The following travel ECU 54 controls the vehicle 10 to follow the preceding vehicle 10A by recognizing the preceding vehicle 10A by the external sensor 42. The following travel ECU 54 also controls the vehicle 10 to follow the preceding vehicle 10A by communicating with the preceding vehicle 10A. The following traveling ECU 54 controls the engine actuator, the brake actuator, and the steering actuator of the succeeding vehicle 10B such that the preceding vehicle 10A and the predetermined inter-vehicle distance are maintained. Known techniques may be adopted for the follow-up control of the preceding vehicle 10A.

The road surface drawing ECU 55 draws a predetermined-shape display on the road surface by emitting light with the road surface drawing device 45 as the in-vehicle device 40. The road surface drawing device 45 is provided in front of the vehicle 10. The road surface drawing device 45 includes, for example, a semiconductor light emitting element such as a LED, a first lens for projecting light emitted from the semiconductor light emitting element onto a projection screen, and a second lens for drawing an image of a predetermined shape on the projection screen toward the road surface. In the projection screen, a transmission region corresponding to a predetermined shape to be drawn on the road surface may be formed from the beginning. Further, light of various patterns may be transmitted by selectively driving a plurality of elements arranged in a matrix like a transmissive liquid crystal.

The road surface drawing ECU 55 includes a road surface drawing unit 61, an inter-vehicle communication confirmation unit 62, a headlight confirmation unit 63, a vehicle stop confirmation unit 64, a pedestrian warning unit 65, a display color changing unit 66, an emission range changing unit 67, and a steering angle interlocking unit 68, which will be described later.

While the vehicle 10 travels following the preceding vehicle 10A, the road surface drawing unit 61 emits the road surface between the vehicle 10 and the preceding vehicle 10A with light by the road surface drawing device 45 to draw a predetermined-shaped display on the road surface (hereinafter, simply road surface drawing is performed). At this time, the display may be turned on or the display may be flashed. With such a configuration, it is possible to suppress interruption between the preceding vehicle 10A and the succeeding vehicle 10B without performing complicated traveling control of the succeeding vehicle 10B (vehicle 10) while the succeeding vehicle 10B (vehicle 10) follows the preceding vehicle 10A.

The display shape of the road surface drawing may be a fan shape when viewed from the preceding vehicle 10A, and may be a shape having a plurality of gaps along the circumferential direction (see FIG. 1). Further, as shown in the drawing 3A, the display shape of the road surface drawing is "!" in a substantially triangular shape It may be a hollowed-out shape. Further, as shown in the drawing 3B, the shape may be a shape in which a "-" is hollowed out in a round shape. Further, as shown in the drawing 3C, the displayed shape of the road surface drawing may be a shape obtained by combining ○ and ×.

The display color of the road surface drawing may be green. The display color changing unit 66 may change the display color of the road surface drawing in accordance with the color of the road surface on which the vehicle 10 is traveling.

The inter-vehicle communication confirmation unit 62 executes road surface drawing when the succeeding vehicle 10B (vehicle 10) is connected to the preceding vehicle 10A by vehicle-to-vehicle communication. At this time, the inter-vehicle communication confirmation unit 62 may sequentially perform road surface drawing by the road surface drawing device 45 while attempting to connect the preceding vehicle 10A and the vehicle-to-vehicle communication.

The headlight confirmation unit 63 performs road surface drawing when the headlight of the vehicle 10 is turned on. With such a configuration, the road surface drawing device 45 does not draw the display in the daytime when the headlight is not turned on. As a result, the amount of light at the time of drawing the road surface by the road surface drawing device 45 can be suppressed to be equal to or less than a predetermined amount of light. As a result, the power consumption of the road surface drawing device 45 can be reduced.

The vehicle stop confirmation unit 64 executes road surface drawing when the vehicle 10 is stopped or is lower than or equal to a predetermined vehicle speed. The predetermined vehicle speed may be, for example, the same predetermined vehicle speed as the operating condition of the parking support brake executed by ADAS-ECU 52. The parking support brake is a brake that contributes to the reduction of the collision damage with the operation target by the alarm and the collision damage reduction brake control when the operation target is detected during the low-speed traveling such as the parking. The predetermined vehicle speed may be, for example, a 15 km/h.

With the above configuration, the road surface drawing is not executed by the road surface drawing device 45 at a vehicle speed (high speed) larger than a predetermined vehicle speed at which a pedestrian does not enter between the preceding vehicle 10A and the succeeding vehicle 10B. Thus, the power consumption of the road surface drawing device 45 can be reduced. Further, for example, when the succeeding vehicle 10B is stopped prior to the following traveling in an unmanned manner, it is possible to cause the pedestrian around the succeeding vehicle 10B to recognize that the succeeding vehicle 10B is going to travel by following traveling. Consequently, it is possible to suppress a pedestrian around the succeeding vehicle 10B from passing in front of the succeeding vehicle 10B that travels following.

When a pedestrian is detected within a predetermined range behind the preceding vehicle 10A or within a predetermined range ahead of the succeeding vehicle 10B, the pedestrian warning unit 65 sets the display color of the road surface drawing to red. The predetermined range may be, for example, the same predetermined range as the operating condition of the parking support brake described above. The predetermined area may be a 3 m × 3 m. Accordingly, when a pedestrian tries to enter between the preceding vehicle 10A and the succeeding vehicle 10B (vehicle 10), the pedestrian can be warned.

The display color changing unit 66 changes the display color of the road surface drawing to a highly attractive color according to the road surface color detected by the road surface color detection sensor. For example, when the vehicle 10 travels indoors and the road surface color detected by the road surface color detection sensor is black, the display color changing unit 66 changes the display color of the road surface drawing to white. As a result, the display of the road surface drawing can be made conspicuous with respect to the road surface color, and the pedestrian in the vicinity can easily recognize the display of the road surface drawing.

As illustrated in FIG. 4, when the inter-vehicle distance to the preceding vehicle 10A detected by the external sensor 42 is less than or equal to the predetermined distance, the emission range changing unit 67 does not partially display the display-shape of the road surface drawing. With such a configuration, it is possible to avoid a situation in which the road surface drawing is displayed overlapping with the preceding vehicle 10A or the succeeding vehicle 10B when the distance between the preceding vehicle 10A and the succeeding vehicle 10B falls within a predetermined distance.

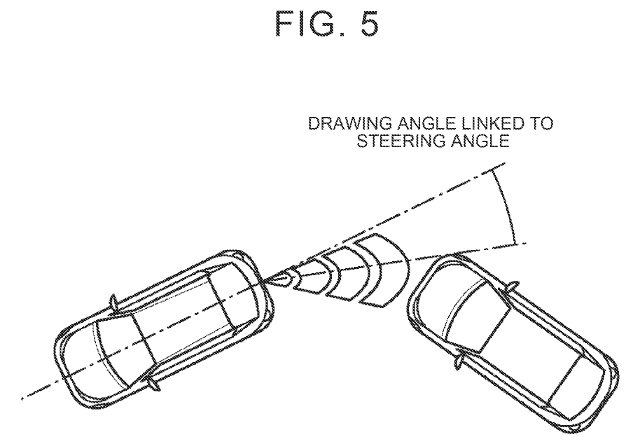

As illustrated in FIG. 5, the steering angle interlocking unit 68 interlocks the drawing angle of the road surface drawing by the road surface drawing device 45 with the steering angle detected by the steering angle sensor 43. With such a configuration, an indication can be drawn between the preceding vehicle 10A and the succeeding vehicle 10B along the curve as the preceding vehicle 10A or the succeeding vehicle 10B passes through the curve.

### Vehicle following traveling control

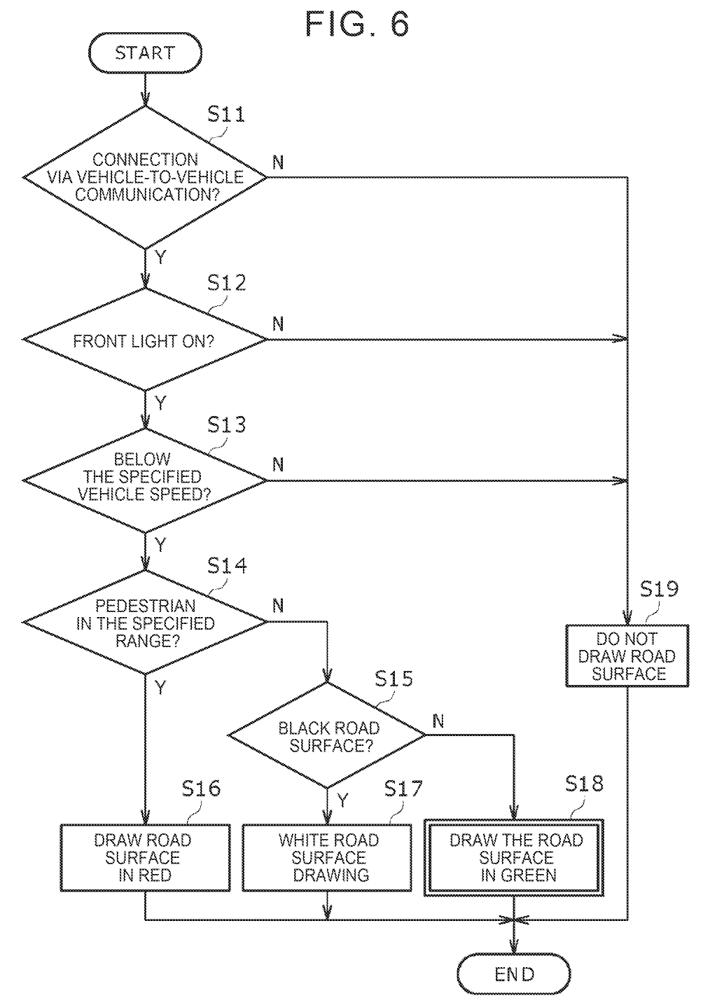

The operation of the road surface drawing ECU 55 will be described with reference to FIG. 6.

The following also describes cases where the vehicle 10 is the succeeding vehicle 10B. In S11, the road surface drawing ECU 55 confirms whether the vehicle 10 has been connected to the preceding vehicle 10A by vehicle-to-vehicle communication. When the road surface drawing ECU 55 can be connected to the preceding vehicle 10A by vehicle-to-vehicle communication, the process proceeds to S12. When the road surface drawing ECU 55 cannot be connected to the preceding vehicle 10A by vehicle-to-vehicle communication, the process proceeds to S19.

In S12, the road surface drawing ECU 55 checks whether or not the headlight of the vehicle 10 is turned on. When the headlight of the vehicle 10 is on, the road surface drawing ECU 55 shifts to S13. When the headlight of the vehicle 10 is not turned on, the road surface drawing ECU 55 shifts to S19.

In S13, the road surface drawing ECU 55 checks whether the vehicle 10 is stopped or is at or below a predetermined vehicle speed. The road surface drawing ECU 55 shifts to S14 when the vehicle 10 is stopped or is at or below a predetermined vehicle speed. When the vehicle 10 is stopped or is higher than the predetermined vehicle speed, the road surface drawing ECU 55 shifts to S19.

In S14, the road surface drawing ECU 55 checks whether a pedestrian is detected within a predetermined range behind the preceding vehicle 10A or within a predetermined range ahead of the succeeding vehicle 10B. When a pedestrian is detected, the road surface drawing ECU 55 proceeds to S16. If the road surface drawing ECU 55 does not detect a pedestrian, the process proceeds to S15.

In S15, the road surface drawing ECU 55 checks whether the road surface color detected by the road surface color detection sensor is black. When the road surface color is black, the road surface drawing ECU 55 shifts to S17. When the road surface color is not black, the road surface drawing ECU 55 shifts to S18.

In S16, the road surface drawing ECU 55 executes road surface drawing by using the road surface drawing device 45 as a red color for displaying road surface drawing. In S17, the road surface drawing ECU 55 executes road surface drawing by using the road surface drawing device 45 as a white color for displaying road surface drawing.

In S18, the road surface drawing ECU 55 executes road surface drawing by using the road surface drawing device 45 as a green color for displaying road surface drawing. In S19, the road surface drawing ECU 55 does not execute road surface drawing by the road surface drawing device 45.

### When the road surface drawing device is located on the rear side of the vehicle

When the road surface drawing device 45 is provided on the rear side of the vehicle 10, the preceding vehicle 10A performs road surface drawing toward the rear side. Again, the above-described operations are performed by the road surface drawing ECU 55.

### When the road surface drawing device is on the front side and the rear side of the vehicle

When the road surface drawing device 45 is provided on the front side and the rear side of the vehicle 10, the road surface drawing may be performed so that the preceding vehicle 10A faces rearward. The succeeding vehicle 10B may perform road surface drawing toward the front, and the preceding vehicle 10A and the succeeding vehicle 10B may perform road surface drawing. Again, the above-described operations are performed by the road surface drawing ECU 55.

### SUMMARY

The disclosure is further illustrated by the following embodiments.

### Configuration 1:

A vehicle following traveling system for non-mechanically linking a preceding vehicle and a succeeding vehicle and causing the preceding vehicle to follow the succeeding vehicle, While the succeeding vehicle is caused to travel following the preceding vehicle, a predetermined shape of the display is drawn on the road surface by emitting light from the preceding vehicle or the succeeding vehicle toward a road surface between the preceding vehicle and the succeeding vehicle. Vehicle following traveling system.

### Configuration 2:

The vehicle following traveling system according to the configuration 1, When the headlight of the preceding vehicle or the succeeding vehicle is lit, to draw the display, Vehicle following traveling system.

### Configuration 3:

The vehicle following traveling system according to the configuration 1, If the preceding vehicle or the succeeding vehicle is stopped or below a predetermined vehicle speed, rendering the display, Vehicle following traveling system.

### Configuration 4:

The vehicle following traveling system according to the configuration 1, If a pedestrian is detected within a predetermined range behind the preceding vehicle or within a predetermined range ahead of the succeeding vehicle, the display is rendered in red. Vehicle following traveling system.

### Configuration 5:

The vehicle following traveling system according to any one of configurations 1 to 4, The drawing angle of the road surface drawing is interlocked with the steering angle of the preceding vehicle or the succeeding vehicle, Vehicle following traveling system.

It should be noted that the present disclosure is not limited to the above-described embodiments and modifications thereof, and it goes without saying that various changes and improvements can be made within the scope of the matters described in the claims of the present application.

What is claimed is:

1. A vehicle following traveling system for non-mechanically linking a preceding vehicle and a succeeding vehicle with the preceding vehicle causing the succeeding vehicle to travel following the preceding vehicle, wherein while the preceding vehicle is causing the succeeding vehicle to travel following the preceding vehicle, light is emitted from the preceding vehicle or the succeeding vehicle toward a road surface between the preceding vehicle and the succeeding vehicle, to draw a display with a predetermined shape on the road surface.

2. The vehicle following traveling system according to claim 1, wherein, when a headlight of the preceding vehicle or the succeeding vehicle is on, the display is drawn.

3. The vehicle following traveling system according to claim 1, wherein, when the preceding vehicle or the succeeding vehicle is stopped or is traveling at a speed no faster than a predetermined vehicle speed, the display is drawn.

4. The vehicle following traveling system according to claim 1, wherein, when a pedestrian is detected within a predetermined range behind the preceding vehicle or within a predetermined range ahead of the succeeding vehicle, the display is drawn in red.

5. The vehicle following traveling system according to claim 1, wherein a drawing angle of the display is synchronized with a steering angle of the preceding vehicle or the succeeding vehicle.
